(19) United States
(12) Patent Application Publication
(10) Pub. No.: US 2021/0342744 A1
(43) Pub. Date: Nov. 4, 2021

(54) RECOMMENDATION METHOD AND SYSTEM AND METHOD AND SYSTEM FOR IMPROVING A MACHINE LEARNING SYSTEM

(71) Applicant: ELEMENT Al Inc., Montreal (CA)

(72) Inventors: Francis DUPLESSIS, Montreal (CA); Patrick STEEVES, Montreal (CA)

(21) Appl. No.: 17/280,227

(22) PCT Filed: Sep. 27, 2019
(86) PCT No.: PCT/IB2019/058238

§ 371 Date: Mar. 26, 2021

Related U.S. Application Data
(60) Provisional application No. 62/738,382, filed on Sep. 28, 2018.

(51) Int. Cl. G06N 20/00; G06F 16/2457

(52) U.S. Cl. CPC G06N 20/00; G06N 3/08; G06F 16/24578

(57) ABSTRACT

There is described a method for improving a machine learning system, the method comprising: determining an uncertainty of an output data of the machine learning system using an uncertainty of an input data of the machine learning system; comparing the determined uncertainty to a threshold; if the determined uncertainty is greater than the threshold, determining a query adequate for decreasing the uncertainty of the output data; transmitting the query to a source of data; receiving a response to the query; and updating the input data of the machine learning, thereby decreasing the uncertainty of the output data.

### TECHNICAL FIELD

The present invention relates to the field of recommendation systems and machine learning

### BACKGROUND

In the context of retail for example, it may be valuable to provide accurate recommendations about products and services to customers in order to increase the number of sales. However, in some instances, some information about the customer may be missing to offer an accurate recommendation to the customer. The chances that the customer would buy a recommended product or service may be limited if the recommendation of the product or service to the customer is not accurate.

Therefore, there is a need for an improved method and system for making recommendations to users or customers.

The performance of an ML task can be analyzed from its two major components: the algorithm that defines the ML system itself, and the data that the ML system ingests. Most work focuses on improving the ML system through algorithms or architecture improvements such as more powerful decision trees, support vector machines, neural networks, etc.

The efficiency of such an ML system also depends on the quality of the data being consumed by the ML system. Data cleaning may be an important step to achieve a suitable level of quality.

In some instances, the raw data itself may be of poor quality and nothing can be done to improve it. In certain cases, especially during inference, it may be possible to query the source of input data in order to sharpen the quality. For example, if certain features of input data may be missing or uncertain, then the best passive approach is to estimate its value based on the algorithm's current knowledge of the sample or the population. This technique is known as imputation in the field of statistics and can be done via different prior art methods.

When possible, an active approach is to query additional information from an external data source in order to clarify the uncertainty in the input data. However, when the action of querying additional information from an external data source may be computationally costly and/or time consuming, the number of times that a query is performed may be restricted, thereby limiting the improvement of the quality of the input data.

Therefore, there is a need for an improved method and system for improving machine learning systems.

### SUMMARY

According to a first broad aspect, there is provided a computer-implemented method for improving a machine learning system, the method comprising: determining an uncertainty of an output data of the machine learning system using an uncertainty of an input data of the machine learning system; comparing the determined uncertainty to a threshold; if the determined uncertainty is greater than the threshold, determining a query adequate for decreasing the uncertainty of the output data; transmitting the query to a source of data; receiving a response to the query; and updating the input data of the machine learning, thereby decreasing the uncertainty of the output data.

In one embodiment, the uncertainty of the input data is a random variable, a distribution of the random variable being one of known and estimated.

In one embodiment, the uncertainty of the output data is represented by a metric score.

In one embodiment, the method further comprises determining the metric score by introspection of the machine learning system.

In another embodiment, the method further comprises determining the metric score by repeatedly sampling the uncertainty of the input data and monitoring a response of the machine learning system.

In one embodiment, the distribution of the random variable is unknown, the method further comprising estimating the distribution using one of a bootstrapping method, a Kernel density estimation, a Generative Adversarial Networks and a Gaussian Process.

In one embodiment, the query is directed to a specific feature.

In one embodiment, the query is used to obtain information adequate for peaking the distribution of the random variable to a given set of values.

In one embodiment, the method further comprises generating sample outputs from the metric score and ranking an uncertainty of features being beneficial to reduce.

In one embodiment, the step of ranking is performed using partial dependency plots (PDP) and individual conditional expectation (ICE).

In another embodiment, the step of ranking is performed using a Shapley value when more than one query is to be performed before updating the input data.

According to a second broad aspect, there is provided a system for improving a machine learning system, the system comprising: a scoring unit configured for determining an uncertainty of an output data of the machine learning system using an uncertainty of an input data of the machine learning system; and a query determining unit configured for: comparing the determined uncertainty to a threshold; if the determined uncertainty is greater than the threshold, determining a query adequate for decreasing the uncertainty of the output data; transmitting the query to a source of data; receiving a response to the query; and updating the input data of the machine learning, thereby decreasing the uncertainty of the output data.

In one embodiment, the uncertainty of the input data is a random variable, a distribution of the random variable being one of known and estimated.

In one embodiment, the scoring unit is configured for calculating a metric score representing the uncertainty of the output data.

In one embodiment, the scoring unit is configured for calculating the metric score by introspection of the machine learning system.

In another embodiment, the scoring unit is configured for calculating the metric score by repeatedly sampling the uncertainty of the input data and monitoring a response of the machine learning system.

In one embodiment, the distribution of the random variable is unknown, the scoring unit being further configured for estimating the distribution using one of a bootstrapping method, a Kernel density estimation, a Generative Adversarial Networks and a Gaussian Process.

In one embodiment, the query is directed to a specific feature.

In one embodiment, the query is used to obtain information adequate for peaking the distribution of the random variable to a given set of values.

In one embodiment, the scoring unit is further configured for generating sample outputs from the metric score and ranking an uncertainty of features being beneficial to reduce.

In one embodiment, the scoring unit is configured for performing the ranking using partial dependency plots (PDP) and individual conditional expectation (ICE).

In another embodiment, the scoring unit is configured for performing the ranking using a Shapley value when more than one query is to be performed before updating the input data.

According to a third broad aspect, there is provided a computer-implemented method for improving a machine learning system, the method comprising: inputting an input data having an uncertainty associated thereto into a machine learning system, thereby obtaining an output data, the machine learning being previously trained using a loss function configured for penalizing querying of information that would decrease an uncertainty to the output data; determining whether a query is required from a flag in the output data; when the flag indicates that a query is required, determining a query adequate for increasing a performance of the machine learning system on the loss function; transmitting the query to a source of data; receiving a response to the query; and updating the input data of the machine learning, thereby increasing the performance of the machine learning system on the loss function.

In one embodiment, the loss function includes a term that counts a number of queries.

In one embodiment, the machine learning system has a neural network architecture.

In one embodiment, the neural network architecture comprises one of a recurrent neural network architecture and an attention mechanism architecture.

In one embodiment, in a training of the machine learning system is performed by at least one of randomly masking features and adding noise in an input of training data to simulate uncertainty and adding back a true value if queried.

In one embodiment, the flag comprises a flag vector denoting uncertain components, the method further comprising concatenating the flag vector.

According to another broad aspect, there is provided a machine learning system, the system comprising: a machine learning unit for outputting an output data from an input data having an uncertainty associated thereto, the machine learning unit being previously trained using a loss function configured for penalizing querying of information that would decrease an uncertainty to the output data; a query determining unit configured for: determining whether a query is required from a flag in the output data; when the flag indicates that a query is required, determining a query adequate for increasing a performance of the machine leaning system on the loss function; and transmitting the query to a source of data; and an update unit configured for receiving a response to the query and updating the input data of the machine learning to increase the performance of the machine leaning system on the loss function.

In one embodiment, the loss function includes a term that counts a number of queries.

In one embodiment, the machine learning system has a neural network architecture.

In one embodiment, the neural network architecture comprises one of a recurrent neural network architecture and an attention mechanism architecture.

In one embodiment, a training of the machine learning system is performed by at least one of randomly masking features and adding noise in an input of training data to simulate uncertainty and adding back a true value if queried.

In one embodiment, the flag comprises a flag vector denoting uncertain components, the method further comprising concatenating the flag vector.

According to a further broad aspect, there is provided a computer-implemented method for generating a recommendation for a user, the method comprising: using information about the user, determining a first value for a level of confidence that a recommendation to a user would be accurate; comparing the first value for the level of confidence to a threshold; when the first value for the level of confidence is less than the threshold, determining a query adapted to increase the first value for the level of confidence; transmitting the query to an external data source; receiving a response to the query; determining a second value for the level of confidence using the received information and the response to the query; comparing the second value for the level of confidence to the threshold; when the second value for the level of confidence is at least greater than the threshold, determining the recommendation for the user; and outputting the recommendation.

In one embodiment, the level of confidence is determined by comparing the information about the user to historical information.

In one embodiment, the method further comprises regrouping users having similar user information to create a reference group of users.

In one embodiment, the level of confidence is calculated based on information associated with the reference group of users and the information about the user.

In one embodiment, the method further comprises receiving a user identification (ID) and retrieving the information about the user using the user ID.

According to still another broad aspect there is provided a system for generating a recommendation for a user, the method comprising: a confidence level unit for: receiving information about the user; using the received information, determining a first value for a level of confidence that a recommendation to a user would be accurate; comparing the first value for the level of confidence to a threshold; a querying unit for: when the first value for the level of confidence is less than the threshold, determining a query adapted to increase the first value for the level of confidence; transmitting the query to an external data source; receiving a response to the query, the confidence unit being further configured for determining a second value for the level of confidence using the received information and the response to the query and comparing the second value for the level of confidence to the threshold; and a recommendation unit for: when the second value for the level of confidence is at least greater than the threshold, determining the recommendation for the user; and outputting the recommendation.

In one embodiment, the confidence level unit is configured for determining the level of confidence by comparing the information about the user to historical information.

In one embodiment, the confidence level unit is further configured for regrouping users having similar user information to create a reference group of users.

In one embodiment, the confidence level unit is further configured for calculating the level of confidence based on information associated with the reference group of users and the information about the user.

In one embodiment, the confidence level unit is further configured for receiving a user identification (ID) and retrieving the information about the user using the user ID.

### BRIEF DESCRIPTION OF THE DRAWINGS

Further features and advantages of the present invention will become apparent from the following detailed description, taken in combination with the appended drawings, in which:

FIG. 1 is a flow chart of a method for improving an ML system, in accordance with a first embodiment;

FIG. 2 is a block diagram illustrating a system for improving an ML system, in accordance with an embodiment;

FIG. 3 is a block diagram of a processing module adapted to execute at least some of the steps of the method of FIG. 1, in accordance with an embodiment;

FIG. 4 is a flow chart of a method for improving an ML system, in accordance with a second embodiment;

FIG. 5 is a block diagram illustrating an ML system provided with an internal improvement module, in accordance with an embodiment;

FIG. 6 illustrates the operation in time of an exemplary ML system having internal improvement capabilities, in accordance with an embodiment;

FIG. 7 is a block diagram of a processing module adapted to execute at least some of the steps of the method of FIG. 4, in accordance with an embodiment;

FIG. 8 is a flow chart of a method for generating a recommendation for a user, in accordance with an embodiment;

FIG. 9 is a block diagram illustrating a system for generating a recommendation for a user, in accordance with an embodiment; and

FIG. 10 is a block diagram of a processing module adapted to execute at least some of the steps of the method of FIG. 8, in accordance with an embodiment

It will be noted that throughout the appended drawings, like features are identified by like reference numerals.

### DETAILED DESCRIPTION

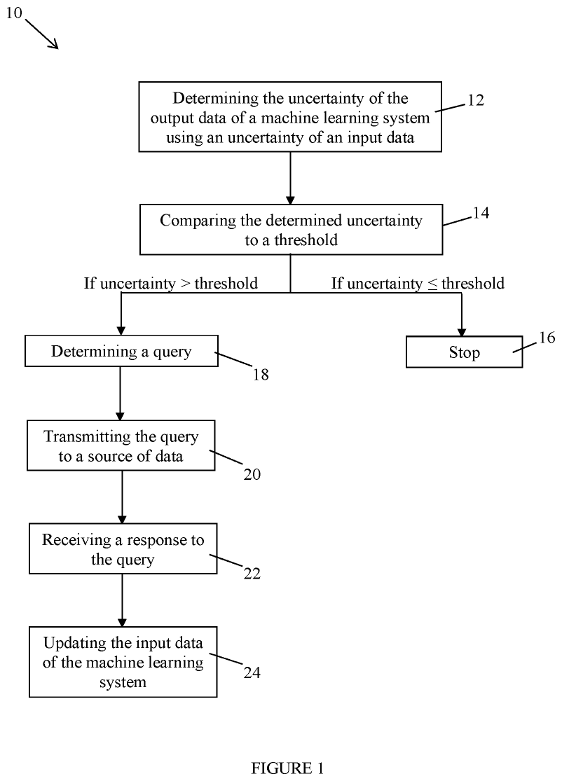

FIG. 1 illustrates a computer-implemented method 10 for improving a ML system in the context of interactive data. The method 10 allows improving the quality of the input data used by the ML system via queries to an external source of data. The method 10 may further allow optimizing/decreasing the number of queries transmitted to the external source of data required for obtaining a desired level of quality for the input data consumed by the ML system.

At step 12, the uncertainty of the output data of the ML system is determined using the uncertainty associated with the input data.

In one embodiment, the input data X may be expressed as follows:

X=X_{known}+X_{uncertain}

Where X_{known} is a vector with known quantities, while X_{uncertain} has some uncertainty associated to it.

In one embodiment, X_{uncertain} is a random variable whose distribution is either known or estimated from the available data. For example, the input data may comprise three values which may include an individual's age, gender and height. If the dataset contains a large number of examples, then an estimate of the distribution P(age, gender, height) may be determined.

If a new individual of 20 year old and female, but of unknown height is to be passed into the ML system, the input data may be written as X_{known}=[20, F, 0] and X_{uncertain}=[0, 0, X_height] where X_height is a random variable with distribution P(height, age=20, gender=F).

In one embodiment, the uncertainty of the output data may be represented by a metric score and step 12 comprises calculating the metric score for the output data of the ML system, as described below. The metric score allows determining whether an attempt to improve the input data's uncertainty is required. This may be done by comparing the metric score to a predefined threshold value.

The metric score is a function that takes in the uncertainty in the ML system's output and turns it into a real number. The uncertainty of the outputs is determined from the uncertainty in the inputs.

In one embodiment, the determination of the metric score is performed by introspection on the ML system. In another embodiment, the determination of the metric score is performed by repeatedly sampling the uncertain features of the input from its distribution and monitoring the response of the ML system.

In an embodiment in which the input's distribution is unknown, one can estimate it through standard estimation techniques such as a bootstrapping method, a Kernel density estimation, Generative Adversarial Networks, a fitting to a model (e.g. Gaussian Process), or the like.

Once it has been determined, the uncertainty of the output of the ML system is compared to a predefined threshold at step 14. For example, the calculated metric score may be compared to a threshold score.

If the uncertainty of the output of the ML system is less than or equal to the threshold, then the method 10 is stopped at step 16. In this case, the uncertainty associated with the output is considered as being acceptable.

If the uncertainty of the output of the ML system is greater than the threshold, then a query for information is determined at step 18. The query is chosen so as to decrease the uncertainty of the input of the ML system so as to consequently decrease the uncertainty of the output.

In one embodiment, the query is directed to a specific feature such as a desired specific piece of information. In another embodiment, the query is used to obtain information that will help peaking the distribution of the random variable to a certain set of values.

Referring back to the above example, the query may represent the best action to take to gather the most relevant information from X_(uncertain).

The person skilled in the art will understand that the exact mechanism depends on the problem at hand. With reference to the above example, the query may be a request for the person's height.

In an embodiment in which a metric score is determined, similar sampling techniques used to determine the metric score may be employed to generate sample outputs which are then used to rank which feature's uncertainty would be most beneficial to reduce.

Let M: X_{input}->Y_{output} be the function that denotes the ML system, then a sample output Y is the action of M on a sample input X. The sample input is generated from sampling the distribution P(X_{uncertain}) and creating a sample X_{sample input}=X_{known}+X_{sampled, uncertain} and obtaining Y_{sample output}=M(X_{sample input}).

The ranking may be done using simple techniques such as partial dependency plots (PDP) and individual conditional expectation (ICE) or using more involved concepts such as the Shapley value when more than one query is to be performed before updating the input.

In one embodiment, an additional cost term may be considered in order to place more weight on the penalty of querying difficulty to obtain information (not all information may have the same cost of retrieval).

In the following, there is described several exemplary methods for determining the query adequate decreasing the uncertainty of the output of the ML system

In an embodiment in which the external source of data to which the query is to be transmitted is a human data source and the uncertain feature is intuitive, the query may be a question directed to a human being.

In one embodiment, the external source of data to which the query is to be transmitted may be a human data source and the uncertain feature may be unintuitive. Different approaches may be followed. For example, if only a subset of the features are unintuitive, the query may be based only on the uncertain features that are intuitive and the uncertain features that are unintuitive may be ignored. In this case, the query may comprise at least one question to be answered by a human being. In another example, for each unintuitive feature, a set of questions that extracts the necessary information may be crafted and then the information is used to reconstruct the value of the unintuitive feature. For example, if one (unintuitive) feature is the sum of a user's height and the user's feet length, questions such as “What is your height?” and “What shoe size do you wear?” may be crafted. These questions are then asked when this feature is flagged as an important but uncertain variable.

It should be understood that when the external data source is a human data source, the query is to be sent to a user interface through which the human being is to input information such as the response to a question.

In an embodiment in which input features may be values obtained from a large simulation (e.g., the number of galaxies above 10\hat{ }6 solar mass at the end of an N-body simulation such as the Millenium simulation), the query may be a request to be transmitted to the simulation's API in order to run the simulation and return the value of the missing feature.

In an embodiment, in which the uncertain input feature may be the result of a laboratory experiment, the query may be a request to the laboratory operator to perform an experiment and report back the result.

In an embodiment in which the external data source is an external database which may be slow access or expensive to query, an appropriate query may be crafted for each feature that can be extracted from the external database. The query would then be pushed to the external database when needed. For example, SQL queries may be generated and transmitted to an SQL database on Azure.

Referring back to FIG. 1, once it has been generated, the query is transmitted to the external source of data. As described above, the external source of data may be a user device provided with a user interface configured for providing a user with the query and allowing the user to input information in response to the query. The user may be a customer, a laboratory operator, etc. In another example, the query may be transmitted to a computer or server that runs a simulation API for example. In a further embodiment, the query may be sent to an external database.

At step 22, the response to the query is received. As described above, the response to the query may be received form a user device, a computer or server, an external database, etc.

At step 24, the response to the query is used for updating the input data of the ML system.

Referring back to the above example, the value of X_{known) and that of X_{uncertain} are updated. When the query was a question asking the height of the user, the response to the query is indicative of the height of the user. The update of the input vector is performed by setting the correct value so as to obtain: X_{known)=[20, F, height], X_{uncertain}=[0,0,0]. The input vector would then have no more uncertainty. In an example in which the response to the query would be a range of height, then the uncertainty in X_{uncertain} could decrease, but not entirely.

In one embodiment, the steps 12-14 may be repeated until the uncertainty of the output be less than the threshold or until the method is stopped by a human being for example.

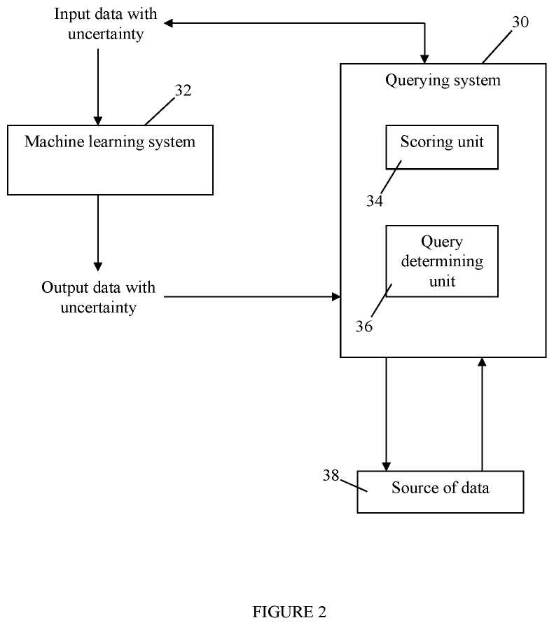

FIG. 2 illustrates one embodiment of a querying system 30 used for improving a ML system 32. In the illustrated embodiment, the querying system 30 is external to the ML system 32 and may be used with different ML systems interchangeably.

The querying system 30 comprises a scoring unit/module 34 and a query determining unit/module 36. The scoring unit 34 is configured for determining the uncertainty of the output of the ML system 32 using the uncertainty of the input of the ML system 32, using the above-described method. The determined uncertainty value is transmitted to the query determining unit 36 which compares the received uncertainty value to a threshold and generates a query when the received uncertainty value is greater than a predefined threshold. The query determining unit 36 is further configured for transmitting the determined query to an external source of data 38 and receiving the response to the query from the source of external data. Upon receipt of the response to the query, the query determining unit 36 updates the input data according to the response to the query.

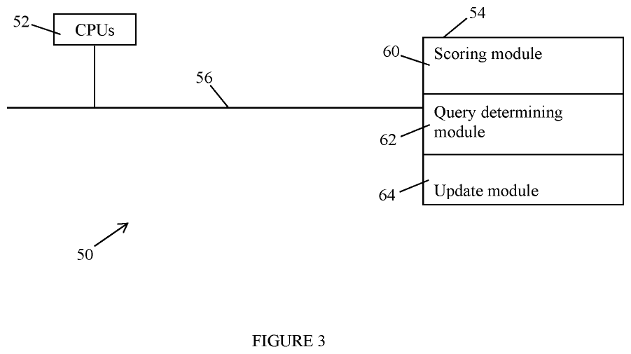

FIG. 3 is a block diagram illustrating an exemplary processing module 50 for executing the steps 12 to 24 of the method 10, in accordance with some embodiments. The processing module 50 typically includes one or more Computer Processing Units (CPUs) and/or Graphic Processing Units (GPUs) 52 for executing modules or programs and/or instructions stored in memory 54 and thereby performing processing operations, memory 54, and one or more communication buses 56 for interconnecting these components. The communication buses 56 optionally include circuitry (sometimes called a chipset) that interconnects and controls communications between system components. The memory 54 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 54 optionally includes one or more storage devices remotely located from the CPU(s) and/or GPUs 52. The memory 54, or alternately the non-volatile memory device(s) within the memory 54, comprises a non-transitory computer readable storage medium. In some embodiments, the memory 54, or the computer readable storage medium of the memory 54 stores the following programs, modules, and data structures, or a subset thereof:
a scoring module 60 for determining the uncertainty of the output of an ML system;
a query determining module 62 for comparing the determined uncertainty of the output to a threshold, generating a query when the uncertainty of the output is greater than a threshold and transmitting the query to an external source of data; and
an update module 64 for receiving the response to the query from the external source of data and updating the input data of the ML system according to the received response to the query.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, the memory 54 may store a subset of the modules and data structures identified above. Furthermore, the memory 54 may store additional modules and data structures not described above.

Although it shows a processing module 50, FIG. 3 is intended more as functional description of the various features which may be present in a management module than as a structural schematic of the embodiments described herein. In practice, and as recognized by those of ordinary skill in the art, items shown separately could be combined and some items could be separated.

While the above described method and system for improving an ML system are external to the ML system itself, the following presents a method and system for internally improving an ML system.

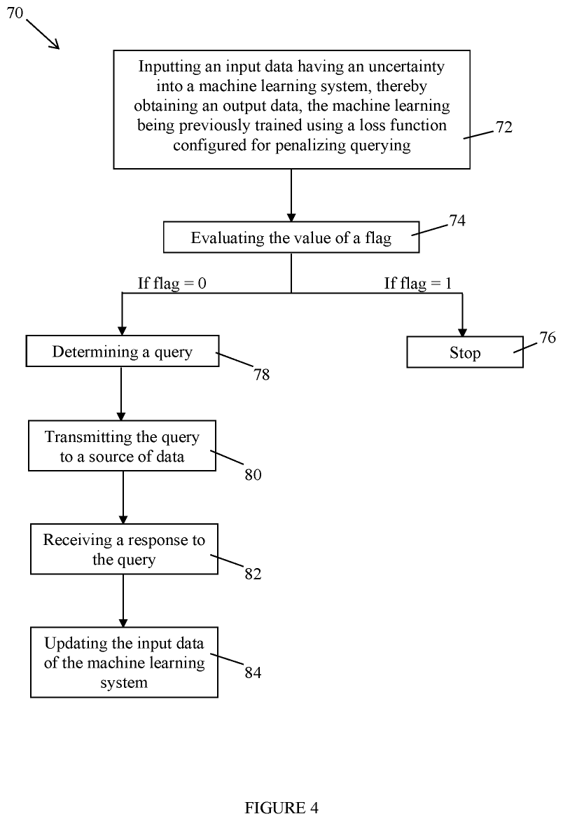

FIG. 4 illustrates one embodiment of a computer-implemented method 70 for internally improving an ML system. The ML system is trained to learn which features would be best to query in order to reduce the uncertainty of the input of the ML system.

At step 72, an input having an uncertainty associated thereto is inputted into the ML system which outputs an output. The ML system has been previously trained using a loss function configured for penalizing querying of information that would decrease the uncertainty to the output. During training, a loss value for the output of the ML system is determined using the loss function that penalizes querying of additional information and the output of the ML system. This forces the ML system to learn to minimize the number of queries and be efficient when it does so.

In one embodiment, the loss function could include a term that counts the number of queries for example. In this case, the loss function could be as follows:

Loss=loss^{standard}(output)+α(query_{number})

where α is weight factor.

For example, the ML system may have a neural network architecture such as Recurrent Neural Network (RNN) or the Attention mechanism.

In one embodiment, the training procedure of the ML system is done by randomly masking features/adding noise in the input of the training data to simulate uncertainty and adding back the true value if queried.

For example, a fixed dataset may be used during training. For each data point, an uncertainty may be simulated by adding an “uncertainty” vector to the input:

X_{input}=X_{known}+X_{uncertainty}

A simple example of an uncertainty vector is a vector comprising 0 for all components except the i^{th} one where,

X_{uncertainty}[i]=−X_{known}[i]+χ

with χ being a random variable.

A flag vector that denotes which components are “uncertain” can be concatenated, thereby allowing the query for a specific feature within this set. A component to be queried, such as the j component, is outputted. Then to simulate the query of the j^{th} component (during training),

X_{input},j=X_{known},j+X_{uncertainty},j

is replaced by,

X_{input},j=X_{known},j

during the update step and the loop is repeated.

At step 74, the value of flag contained in the output of the ML system is evaluated. The value of the flag indicates whether the method 70 should be stopped or whether a query should be generated.

In one embodiment, if the flag value is equal to 1, the method 70 is stopped at step 76.

If the flag is equal to 0, a query adapted to decrease the loss value of the ML system is determined at step 78. The query is determined by the ML system itself which has been previously trained to determine queries.

Once it has been determined, the query is transmitted to an external source of data at step 80. As described above, the external source of data may be a user device, a computer/server, a database, etc.

At step 82, the response to the query is received and the input data of the ML system is updated according to the received response at step 84.

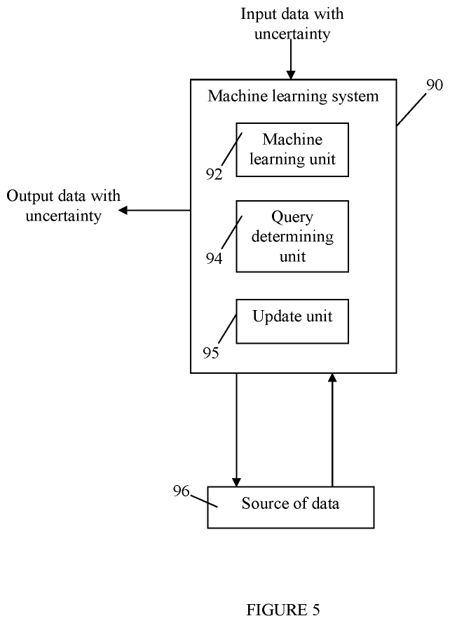

FIG. 5 illustrates one embodiment of an ML system 90 configured for improving itself. The ML system comprises an ML unit/module 92, a query determining unit/module 94 and an update unit 95. The ML unit 92 is configured for outputting an output from an input having an uncertainty associated thereto. As described above, the machine learning unit has been previously trained using a loss function configured for penalizing querying of information that would decrease an uncertainty to the output. The query determining unit 94 determines whether a query is required from a flag in the output data. When the flag indicates that a query is required, the query determining unit 94 determines a query adequate for increasing a performance of the machine leaning system on the loss function, and transmits the determined query to an external source of data 96. The update unit 95 receives the response to the query from the source of external data 96 and updates the input data of the ML system 90 according to the response to the query.

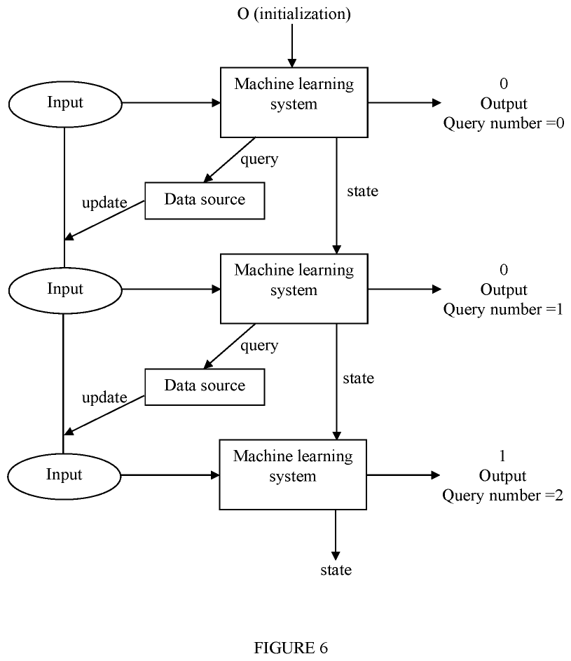

FIG. 6 illustrates the improvement an RNN ML system in time. The RNN ML system requires a state vector that keeps track of its internal state. For the first input of this state vector, an initialization vector, generally set to be the null vector, is fed to the RNN ML system. At t=0, the number of query is equal to zero and the ML system outputs an output. The ML system determines that a query is advantageous. As such it generates an adequate query which is transmitted to an external data source and receives the response to the query from the external data source. The ML system updates the input data according to the received response to the query and also sets the number of query to 1.

Then, the ML system determines a new output using the updated input data. The ML system internally calculates that further querying is required. The ML system determines an adequate query which is transmitted to an external data source and receives the response to the query from the external data source. The ML system updates the input data according to the received response to the query and also sets the number of query to 2.

The ML system determines a further output using the further updated input. The flag equal to 1 indicates that no further query is requested. The ML system then stops determining and transmitting queries and the final output is returned.

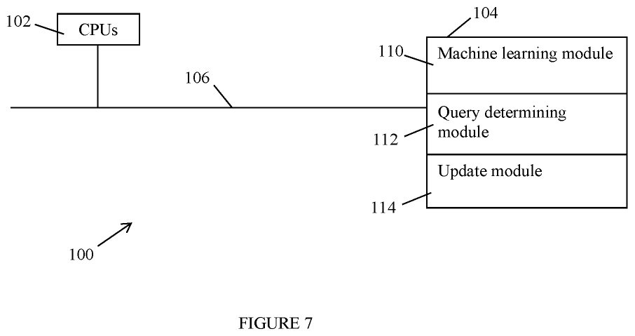

FIG. 7 is a block diagram illustrating an exemplary processing module 100 for executing the steps 72 to 84 of the method 70, in accordance with some embodiments. The processing module 100 typically includes one or more CPUs and/or GPUs 102 for executing modules or programs and/or instructions stored in memory 104 and thereby performing processing operations, memory 104, and one or more communication buses 106 for interconnecting these components. The communication buses 106 optionally include circuitry (sometimes called a chipset) that interconnects and controls communications between system components. The memory 104 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 104 optionally includes one or more storage devices remotely located from the CPU(s) and/or GPUs 102. The memory 104, or alternately the non-volatile memory device(s) within the memory 104, comprises a non-transitory computer readable storage medium. In some embodiments, the memory 104, or the computer readable storage medium of the memory 104 stores the following programs, modules, and data structures, or a subset thereof:
an ML module 110 for determining an output from an input having an uncertainty, the ML module 110 being previously trained using a loss function configured for penalizing querying;
a query determining module 112 for evaluating the value of a flag of the output, generating a query when the flag value is indicates that a query is required and transmitting the query to an external source of data; and
an update module 114 for receiving the response to the query from the external source of data and updating the input data of the ML system according to the received response to the query.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, the memory 104 may store a subset of the modules and data structures identified above. Furthermore, the memory 104 may store additional modules and data structures not described above.

Although it shows a processing module 100, FIG. 7 is intended more as functional description of the various features which may be present in a management module than as a structural schematic of the embodiments described herein. In practice, and as recognized by those of ordinary skill in the art, items shown separately could be combined and some items could be separated.

In the following, there is described a method and system for providing users/customers with a recommendation. The above described querying methods and systems may be used for generating the recommendation.

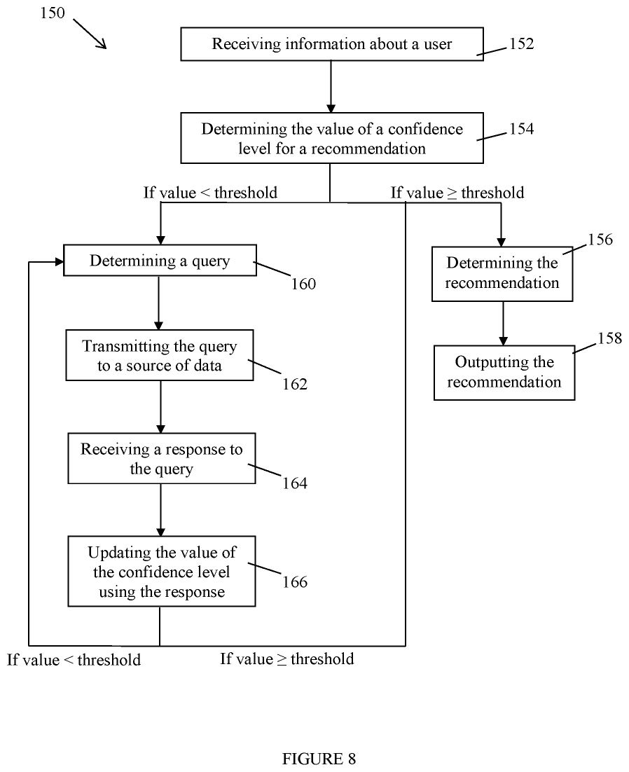

FIG. 8 illustrates one embodiment of a computer-implemented method 150 for generating a recommendation for a user.

At step 152, information about the user is received. The information about the user may comprise information such as a gender, an age, an address, a salary, a purchase history, etc.

At step 154, the value of a level of confidence for making a recommendation to the user is calculated using the user information received at step 152. The recommendation may be directed to any kind of information such as a product, a service, a restaurant, a hotel, a website, etc.

It should be understood that any adequate method for calculating the level of confidence may be used.

In one embodiment, the level of confidence is calculated using the user information and information contained in a database. The database may contain historical information about other users. In this case, the level of confidence is determined by comparing the user information to the historical information. For example, the database may contain information about groups of users and the users of a group have similar characteristics. The groups may be created as a function of a common product that the users of the group have purchased, a common service or service plan that the users of the group have purchased or used, a common university to which the users of the group have attended, a common restaurant that the users of the group have reviewed, etc.

In one embodiment, users having user information similar the user may be regrouped to a form a reference group of users. The level of confidence may be calculated based on the information of the reference group of users and the user information received at step 152. For example, if for each member of the reference group, 10 information elements are known and only nine information elements are known for the user, then one way to assess confidence is to sample the reference group conditioned on the nine known information elements. Model outputs can be determined for the reference group, and the confidence can be determined by computing the variance in the model output across the reference group

In one embodiment, queries that maximizes the mutual information between the ML system (viewed as a random variable, and denoted as R) and its uncertain input being queried (a second random variable, denoted as Xu) are to be determined. The input is a vector and its components are denoted by Xu,i where i is an integer. Hence to determine the confidence of an ML system with respect to a given input, the mutual information between the two can be calculated as follows:

$$I ( R ; {X}_{u , i} ) = {\int }_{R} {\int }_{{X}_{u , i}} p ( R , {X}_{u , i} ) log ( \frac{p ( R , {X}_{u , i} )}{p ( R ) p ( {X}_{u , i} )} ) {dRdX}_{u , i}$$

Here the integral and distribution p(x,y) can be estimated by sampling methods as described above. The person skilled in the art would note that the ML system's response R is correlated with its input Xu. The uncertainty in a variable can be estimated as the expected variation in R obtained by fixing the input Xu,i.

$${σ}_{R , i}^{2} = \int dxp ( x ) \int {dX}_{u} δ ( {X}_{u , i} = x ) \frac{p ( {X}_{u} )}{p ( {X}_{u , i} = x )} ( {R ( {X}_{k} + {X}_{u} )}^{2} - {{𝔼}_{X \text{∼} {X}_{k} + {X}_{u}} ( R \vert {X}_{u , i} = x ) )}^{2} )$$

$${\sum }_{i} ⌊ p ( {x}_{i} ) {\prod }_{j} {\prod }_{k < j} p ( {σ}_{k} \geq {σ}_{j} \vert {x}_{i} ) ⌋$$

For recommender systems, the above equation can be simplified by sampling inputs with the same X_known, outputting the recommendation rankings, and then determining the fraction of times that the ranking changes as a proxy for variance in R, as shown above.

Both of these techniques measures some kind of uncertainty in the ML system. This can be transformed into a confidence score by taking the inverse of the average uncertainty over all input. For instance, le level of confidence may be expressed as:

$$Confidence = {( \frac{1}{N} {\sum }_{i = 1}^{N} {U}_{i} )}^{- 1} , with {U}_{i} ∈ \{ {σ}_{R , i} , I ( R ; {X}_{u , i} ) \}$$

At step 154, the determined level of confidence is further compared to a predefined threshold.

If the level of confidence is equal to or greater than the threshold, a recommendation for the user is generated. It should be understood that any adequate method for generating the recommendation for the user may be used.

In one embodiment, the recommendation for the user is generated by comparing the user information received at step 152 to the information about other users contained in a database using pattern mining methods for example. Using the user information, a profile for the user is created. The information contained in the user profile is compared to the information of the other users to identify users having similar information. The identified users form a reference group of users and the recommendation is then made based on the information about the reference group of users. For example, if the recommendation is directed to a cell phone plan, profiles of other users being similar to the user profile are retrieved and analysed to determine which cell phone plans that the other users have. In one embodiment, the most popular cell phone plane amongst the other users having a similar profile may be recommended to the user. In another embodiment, at least the two most popular cell phone plans may be recommended to the user.

For example, in unsupervised cases, a recommendation can be generated through collaborative filtering that employs techniques such as matrix factorization. Also, a supervised learning approach where a classifier (e.g. SVM, Decision Tree, Neural Networks) is trained on known users and the product they chose can be used. Either method is able to analyze a new user and generate a recommendation.

At step 158, the determined recommendation is outputted. In one embodiment, the recommendation is stored in a local or external memory. In the same or another embodiment, the recommendation is provided to the user. It should be understood that any adequate method for providing the user with the recommendation may be used. For example, the recommendation may be displayed on a user device provided with a display. In another example, the recommendation may be transmitted to the user via an email, a text message, or the like. In a further example, the recommendation may be provided to a person different from the user such as a store employee who will interact with the user.

Referring back to step 154, if the level of confidence is less than the predefined threshold, a query is determined at step 160. The query is chosen so as to increase the level of confidence for the recommendation. For example, the query may comprise a single question or a plurality of questions to be answered by the user.

It should be understood that any adequate method for generating a query adapted to increase the level of confidence may be used. For example, the method 10 illustrated in FIG. 1 may be used. In another example, the method 70 illustrated in FIG. 4 may be used.

Once it has been created, the query is transmitted to an external source of data at step 162. As described above with respect to methods 10 and 70, the external source of data may a user device, a database, etc. For example, the query may comprise a question such as “What is your salary?” and the question is transmitted to a user device via which the user will answer to the question.

At step 164, a response to the query is received. For example, the response may be received from a user device and correspond to the answer to a question. The response to the query is then added to the user information received at step 152. For example, the response to the query may be stored in the user profile.

At step 166, the value of the confidence level is updated using the received response to the query. The level of confidence for the recommendation is recalculated using the user information received at step 152 and the response to the query received at step 166.

The updated value of the level of confidence is then compared to the predefined threshold.

If the updated value of level of confidence is equal to or greater than the threshold, then steps 156 and 158 are performed.

If the updated value of level of confidence is less than the threshold, then steps 160 to 166 may be repeated. In one embodiment, the steps 160 to 166 may be repeated until the value of level of confidence be equal to or greater than the threshold. In another embodiment, the steps 160 to 166 may be repeated a given number of times. In a further embodiment, the steps 160 to 166 may be repeated until an external intervention stops the method 150.

When the repetition of the steps 160 to 166 is stopped before the level of confidence is at least equal to the threshold, no recommendation may be generated. Alternatively, a recommendation may be generated using the actual information known about the user even if the level of confidence is still less than the threshold.

In one embodiment, the method 150 further comprises receiving an identification (ID) from the user and retrieving the user information using the user ID. It should be understood that any adequate method for the user to identify himself may be used. For example, facial recognition may be used to identify the user. In another example, the user may input ID information via a user device. In a further example, the user may log in to an account.

In an embodiment in which the recommendation is directed to a product or service, after the method 150 has been performed, it is determined whether the user has purchased the recommended product or service. This information is stored in the database and may be subsequently used for generating recommendation for other users so that continuous learning may improve the efficiency of the method 150.

In one embodiment, the method 150 may be used in the context of a retail store. When he enters a store, a user may input personal information via a user device such as a tablet for example. In another example, the user may register to an already existing account via a user device such as a tablet present in the store or his personal cell phone. The user information is then used for generating a recommendation using the method 150 and the user is provided with the recommendation. For example, the recommendation may be displayed on the user device.

In one embodiment the user is first asked if he would like a recommendation. If yes, the method 150 is performed. If not, no recommendation is generated.

In one embodiment, the recommendation may be on a particular type of product for example. In this case, the user may be asked to provide the given type of product for which he would like a recommendation. In another example, the type of product may be determined based on the purchase history of the user. Alternatively, the type of product may be automatically determined using the position of the user within the store for example. Any adequate method for determining the position of the user within the store may be used. For example, the position of the user may correspond to the position associated with the table via which he interacts with the system. Alternatively, the position of the user may be determined by localizing his cell phone.

In one embodiment, the presence of the user within the store and the identification of the user may be performed and a recommendation may be automatically provided to the user. For example, face recognition may be used for determining the presence of the user and identifying the user. Information about the user is then retrieved from his account stored in the store database and the method 150 is automatically performed. If a query is required for making the recommendation, the query may be transmitted to a device of the user such as his cell phone.

In one embodiment, the method 150 may be performed in the context of an e-commerce platform. When the user logs in to the platform, the user may be asked if he would like a recommendation. If not, the method 150 is not executed. If yes, the method 150 is executed. In one embodiment, the method 150 is executed without asking the user if he would like a recommendation.

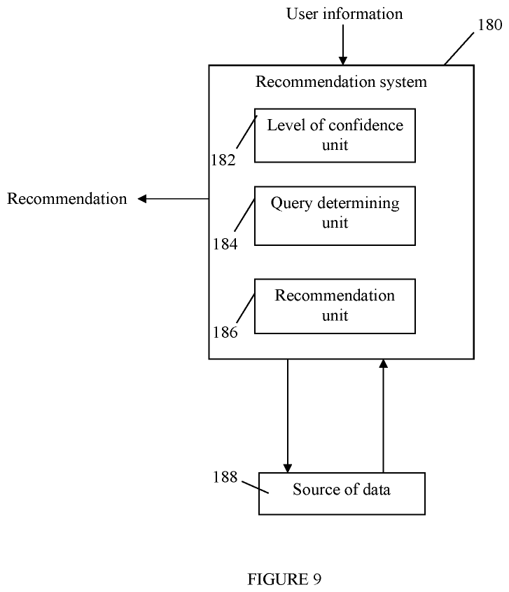

FIG. 9 illustrates one embodiment of a system 180 for generating a recommendation for a user. The system 180 comprises a level of confidence unit/module 182, a query determining unit/module 184 and a recommendation unit/module 186. The level of confidence unit 182 is configured for calculating a level of confidence using information about the user and comparing the level of confidence to a threshold, as described above with respect to method 150. The query determining unit 184 is configured for generating a query when the level of confidence is less than the threshold, transmitting the query to an external source of data, receiving a response to the query from the external source of data and updating the user information using the response to the query, as described above with respect to method 150. The recommendation unit 186 is configured for generating a recommendation adapted to the user and outputting the recommendation, as described above with respect to method 150.

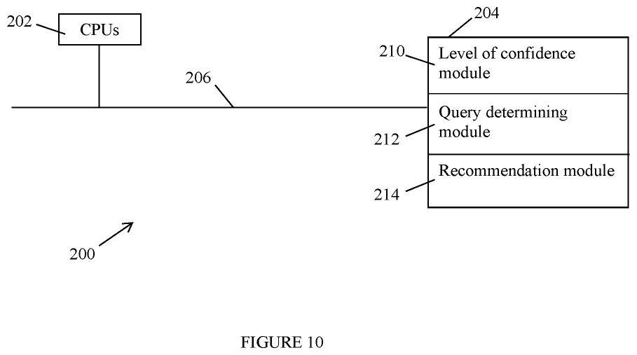

FIG. 10 is a block diagram illustrating an exemplary processing module 200 for executing the steps 152 to 166 of the method 150, in accordance with some embodiments. The processing module 200 typically includes one or more CPUs and/or GPUs 202 for executing modules or programs and/or instructions stored in memory 204 and thereby performing processing operations, memory 204, and one or more communication buses 206 for interconnecting these components. The communication buses 206 optionally include circuitry (sometimes called a chipset) that interconnects and controls communications between system components. The memory 204 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 204 optionally includes one or more storage devices remotely located from the CPU(s) and/or GPUs 202. The memory 204, or alternately the non-volatile memory device(s) within the memory 204, comprises a non-transitory computer readable storage medium. In some embodiments, the memory 204, or the computer readable storage medium of the memory 204 stores the following programs, modules, and data structures, or a subset thereof:
a level of confidence module 210 for calculating a level of confidence using information about the user and comparing the level of confidence to a threshold;
a query determining module 212 for generating a query when the level of confidence is less than the threshold, transmitting the query to an external source of data, receiving a response to the query from the external source of data and updating the user information using the response to the query; and
a recommendation module 214 for generating a recommendation adapted to the user and outputting the recommendation.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, the memory 204 may store a subset of the modules and data structures identified above. Furthermore, the memory 204 may store additional modules and data structures not described above.

Although it shows a processing module 200, FIG. 10 is intended more as functional description of the various features which may be present in a management module than as a structural schematic of the embodiments described herein. In practice, and as recognized by those of ordinary skill in the art, items shown separately could be combined and some items could be separated.

While in the above description, the recommendation method and system are described in the context of recommending a product or a service, it should be understood that the present recommendation method and system may be used for recommending other elements such as recommending a service provider, a store, a restaurant, a hotel, a website, a university, etc.

The embodiments of the invention described above are intended to be exemplary only. The scope of the invention is therefore intended to be limited solely by the scope of the appended claims.

1. A computer-implemented method for improving a machine learning system, the method comprising:
determining an uncertainty of an output data of the machine learning system using an uncertainty of an input data of the machine learning system;
comparing the determined uncertainty to a threshold;
if the determined uncertainty is greater than the threshold, determining a query adequate for decreasing the uncertainty of the output data;
transmitting the query to a source of data;
receiving a response to the query; and
updating the input data of the machine learning, thereby decreasing the uncertainty of the output data.

2. The computer-implemented method of claim 1, wherein the uncertainty of the input data is a random variable, a distribution of the random variable being one of known and estimated.

3. The computer-implemented method of claim 1, wherein the uncertainty of the output data is represented by a metric score.

4. The computer-implemented method of claim 3, further comprising determining the metric score by introspection of the machine learning system.

5. The computer-implemented method of claim 3, further comprising determining the metric score by repeatedly sampling the uncertainty of the input data and monitoring a response of the machine learning system.

6. The computer-implemented method of claim 2, wherein the distribution of the random variable is unknown, the method further comprising estimating the distribution using one of a bootstrapping method, a Kernel density estimation, a Generative Adversarial Networks and a Gaussian Process.

7. (canceled)

8. The computer-implemented method of claim 2, wherein the query is used to obtain information adequate for peaking the distribution of the random variable to a given set of values.

9. The computer-implemented method of claim 3, further comprising generating sample outputs from the metric score and ranking an uncertainty of features being beneficial to reduce.

10. The computer-implemented method of claim 9, wherein said ranking is performed using partial dependency plots (PDP) and individual conditional expectation (ICE).

11. The computer-implemented method of claim 9, wherein said ranking is performed using a Shapley value when more than one query is to be performed before updating the input data.

12. A system for improving a machine learning system, the system comprising:
a scoring unit configured for determining an uncertainty of an output data of the machine learning system using an uncertainty of an input data of the machine learning system; and
a query determining unit configured for:
comparing the determined uncertainty to a threshold;
if the determined uncertainty is greater than the threshold, determining a query adequate for decreasing the uncertainty of the output data;
transmitting the query to a source of data;
receiving a response to the query; and
updating the input data of the machine learning, thereby decreasing the uncertainty of the output data.

13. The system of claim 12, wherein the uncertainty of the input data is a random variable, a distribution of the random variable being one of known and estimated.

14. The system of claim 12, wherein the scoring unit is configured for calculating a metric score representing the uncertainty of the output data.

15. The system of claim 14, wherein the scoring unit is configured for calculating the metric score by introspection of the machine learning system.

16. The system of claim 14, wherein the scoring unit is configured for calculating the metric score by repeatedly sampling the uncertainty of the input data and monitoring a response of the machine learning system.

17. The system of claim 13, wherein the distribution of the random variable is unknown, the scoring unit being further configured for estimating the distribution using one of a bootstrapping method, a Kernel density estimation, a Generative Adversarial Networks and a Gaussian Process.

18. (canceled)

19. The system of claim 13, wherein the query is used to obtain information adequate for peaking the distribution of the random variable to a given set of values.

20. The system of claim 14, the scoring unit is further configured for generating sample outputs from the metric score and ranking an uncertainty of features being beneficial to reduce.

21. The system of claim 20, wherein the scoring unit is configured for performing the ranking using partial dependency plots (PDP) and individual conditional expectation (ICE).

22. The system of claim 20, wherein the scoring unit is configured for performing the ranking using a Shapley value when more than one query is to be performed before updating the input data.

23-44. (canceled)
